(19) United States
(12) Patent Application Publication
(10) Pub. No.: US 2020/0034829 A1
(43) Pub. Date: Jan. 30, 2020

(54) METHOD OF PROVIDING ON A MOBILE ELECTRONIC DEVICE ACCESS TO A NUMBER OF SOURCES OF PRE-ESTABLISHED FUNDS

(71) Applicant: Phoenix Intangibles Holding Company, Greenville, DE (US)

(72) Inventors: SUSAN CARENBAUER, Oakmont, PA (US); Graham Watkins, Scottdale, PA (US); Adam Golomb, Pittsburgh, PA (US); Laura Karet, Pittsburgh, PA (US); Brian Marzullo, New Kensington, PA (US); Brian Kalmar, Cabot, PA (US)

(73) Assignee: Phoenix Intangibles Holding Company, Greenville, DE (US)

(21) Appl. No.: 16/521,930

(22) Filed: Jul. 25, 2019

Related U.S. Application Data
(60) Provisional application No. 62/703,102, filed on Jul. 25, 2018.

(51) Int. Cl. G06Q 20/36; G06Q 20/32; G06Q 20/34

(52) U.S. Cl. CPC G06Q 20/3676; G06Q 20/3274; G06Q 20/342; G06Q 20/325; G06Q 20/3224

(57) ABSTRACT

A method and apparatus provide on a mobile electronic device access to a number of gift cards. The gift cards are stored in a virtual wallet and can be retrieved by the user, whereupon an indicium such as a barcode, QR code, or other indicium is visually displayed or is otherwise output on the mobile electronic device. The indicium can be detected by another device, such as a barcode scanner or a wireless transceiver of a point-of-sale retail system, in order to enable a transaction to be performed using the funds that are associated with the selected gift card. When the user is within a predetermined proximity of a predetermined location, a notification is communicated to the mobile electronic device advising that a gift card in the virtual wallet is available for use at the predetermined location and/or suggesting the purchase gift card that is usable at the predetermined location.

### CROSS REFERENCE TO RELATED APPLICATION

The instant application claims priority from U.S. Provisional Patent Application Ser. No. 62/703,102 filed Jul. 25, 2018, the disclosures of which are incorporated herein by reference.

### BACKGROUND

### Field

The disclosed and claimed concept relates generally to mobile electronic devices and, more particularly, to an application that is usable on a mobile electronic device in order to interact with a virtual wallet that is remote from the mobile electronic device and which has stored therein a set of identification information for each of a number of sources of pre-established funds.

### Related Art

It is well known to sell pre-established funds that may be used at a particular retailer, by way of example, in the form of a gift card or in the form of other such accounts. It is also known for certain retailers to provide rewards to a customer for making purchases with the retailer. One non-limiting example of a retailer providing rewards to a customer is when, for example, a grocery/fuel retailer who sells groceries also sells gasoline, and the reward for purchasing groceries from the retailer is in the form of some type of discount on the purchase of gasoline from the retailer and/or vice-versa. Such a retailer can additionally sell gift cards that are usable with other retailers, and such gift cards can serve as sources of pre-established funds. Depending upon the economics of the sale of such gift cards by the grocery/fuel retailer, the grocery/fuel retailer can offer the same reward for the purchase of a gift card that is usable with another retailer or can offer an enhanced reward, by way of example.

The use of such sources of pre-established funds has not, however, been without limitation. Many sources of pre-established funds are received by the recipient (whether as a gift, by way of example, or by direct purchase by the recipient) in some sort of a physical form, such as on a card that must be retained in order to employ the funds that are associated with the source of pre-established funds in a monetary transaction or other transaction. The constant carrying of such cards by an owner of the cards has been cumbersome, and as a result most users typically keep such cards at home or elsewhere, for instance, with the hope that they will remember that any particular such card exists and will further remember to take it with them to a corresponding retailer when an opportunity to use the pre-established funds has been planned. However, such a strategy has its own limitations since the opportunities to use pre-established funds can present themselves in an unplanned fashion, with the result that the sources of pre-established funds often remain unused for extended periods of time. Furthermore, the user may simply forget after a long duration of time that the sources of pre-established funds exist. Moreover, the owner of the sources of pre-established funds may simply ignore certain sources of pre-established funds when the remaining fund balance becomes relatively low, even though such relatively modest amounts of funds remain completely viable. Improvements thus would be desirable.

### SUMMARY

An improved method and mobile electronic device that are set forth herein, and which are in accordance with the disclosed and claimed concept, provide on the mobile electronic device access to a number of sources of pre-established funds, such as may be embodied or represented by gift cards or the like. As employed herein, the expression “a number of” and variations thereof shall refer broadly to any non-zero quantity, including a quantity of one. The various sources of pre-established funds that are owned by a user are advantageously stored in a virtual wallet and can easily be retrieved by the user from the virtual wallet, whereupon a barcode, QR code, or other indicium that is representative of a selected source of pre-established funds is visually displayed on an electronic display of the mobile electronic device, or is otherwise output. The indicium can be detected by another device, such as a barcode scanner or a wireless transceiver of a point-of-sale retail system, in order to enable a monetary transaction or other transaction to be performed in whole or in part using the pre-established funds that are associated with the selected source of pre-established funds, by way of example.

As such, an aspect of the disclosed and claimed concept is to provide an improved mobile electronic device having an application that is executable thereon which provides wireless communication with a remote storage where a virtual wallet is stored and which includes a set of identification information for each of a number of sources of pre-established funds.

Another aspect of the disclosed and claimed concept is to provide an improved method of storing in a virtual wallet a set of identification information for each of a number of sources of pre-established funds.

Another aspect of the disclosed and claimed concept is to provide an improved method and mobile electronic device that facilitate access to and use of sources of pre-established funds.

Another aspect of the disclosed and claimed concept is to employ GPS data or other location data in order to remind the user of an availability of a source of pre-established funds that can be used at a location where the user is situated or to suggest to the user the purchase of an additional source of pre-established funds that may be used at the location where the user is situated, or both.

Another aspect of the disclosed and claimed concept is to provide an improved method and mobile electronic device that enables the user to add to a virtual wallet sources of pre-established funds, whether the sources of pre-established funds are already in existence or whether they are otherwise being received by a user.

Accordingly, an aspect of the disclosed and claimed concept is to provide an improved method of providing on a mobile electronic device access to a number of sources of pre-established funds, the mobile electronic device having a processor apparatus that includes a processor and a storage, an input apparatus that is structured to provide input signals to the processor apparatus, and an output apparatus that is structured to receive output signals from the processor apparatus. The method can be generally stated as including storing in a virtual wallet a set of identification information for each source of pre-established funds of the number of sources of pre-established funds, outputting on the output apparatus for each source of pre-established funds of at least a subset of the number of sources of pre-established funds a visual representation that corresponds with the source of pre-established funds, detecting on the input apparatus a selection input with respect to the visual representation that corresponds with a particular source of pro-established funds from among the at least subset, and outputting an indicium that is representative of the particular source of pre-established funds and that is detectable by another device to enable the performance of at least a portion of a monetary transaction.

Another aspect of the disclosed and claimed concept is to provide an improved mobile electronic device that is structured to have access to a virtual wallet, the virtual wallet having stored therein a set of identification information for each of a number of sources of pre-established funds. The mobile electronic device can be generally stated as including a processor apparatus that can be generally stated as including a processor and a storage, an input apparatus structured to provide input signals to the processor apparatus, an output apparatus structured to receive output signals from the processor apparatus, the storage having stored therein a number of instructions which, when executed on the processor, are structured to cause the mobile electronic device to perform operations that can be generally stated as including outputting on the output apparatus for each source of pre-established funds of at least a subset of the number of sources of pre-established funds a visual representation that corresponds with the source of pre-established funds, detecting on the input apparatus a selection input with respect to the visual representation that corresponds with a particular source of pre-established funds from among the at least subset, and outputting an indicium that is representative of the particular source of pre-established funds and that is detectable by another device to enable the performance of at least a portion of a monetary transaction.

Another aspect of the disclosed and claimed concept is to provide an improved method of providing on a mobile electronic device access to a reward that is based at least in part upon a purchase of a source of pre-established funds, the mobile electronic device having a processor apparatus that includes a processor and a storage, an input apparatus that is structured to provide input signals to the processor apparatus, and an output apparatus that is structured to receive output signals from the processor apparatus. The method can be generally stated as including receiving from a computerized device a number of inputs that result in a purchase of a source of pre-established funds, the computerized device being one of the mobile electronic device and another electronic device, responsive to the receiving, storing in a virtual wallet a set of identification information for the source of pre-established funds, outputting on the mobile electronic device a visual representation that corresponds with the source of pre-established funds, and adding to a set of rewards a reward that is based at least in part upon the purchase of the source of pre-established funds, the set of awards being associated with at least one of the virtual wallet and an owner of the virtual wallet

### BRIEF DESCRIPTION OF THE DRAWINGS

A further understanding of the disclosed and claimed concept can be gained from the following Description when read in conjunction with the accompanying drawings in which:

FIG. 1 is a schematic depiction of an improved mobile electronic device in accordance with the disclosed and claimed concept;

FIG. 2 is a schematic depiction of the environment in which the mobile electronic device of FIG. 1 and an enterprise system are usable in order to establish and employ a virtual wallet that is stored on the enterprise system;

FIG. 3-13 are depictions of exemplary dialog screens that are output on a visual display of the mobile electronic device of FIG. 1;

FIG. 14 is a flowchart depicting certain aspects of an improved method in accordance with an aspect the disclosed and claimed concept; and

FIG. 15 is a flowchart depicting certain aspects of an improved method in accordance with another aspect the disclosed and claimed concept.

Similar numerals refer to similar parts throughout the specification.

### DESCRIPTION

As can be understood from FIG. 1, a mobile electronic device 4 in accordance with the disclosed and claimed concept can be characterized as including a processor apparatus 8 having a processor 12 and a storage 16 that are in communication with one another. The storage 16 can be in the form of any of a wide variety of non-transitory storage media such as RAM, ROM, EPROM, EEPROM, FLASH, and the like. The storage has a number of routines 20 stored therein which comprise instructions that are executable on the processor 12 to cause the mobile electronic device 4 to perform certain operations such as those that are set forth elsewhere herein.

The mobile electronic device 4 further includes an input apparatus 24 that is configured to provide input signals to the processor apparatus 8, an output apparatus 28 that is configured to receive output signals from the processor apparatus 8, and a wireless communication apparatus 32 that is in communication with the processor apparatus 8 and that provides wireless communication capabilities with other wireless equipment and particularly can include a cellular transceiver, a Wifi transceiver, a Bluetooth transceiver, and the like without limitation. Portions of the communication apparatus 32 can be considered to be a part of the input apparatus 24 and/or a part of the output apparatus 28. For instance, if the communication apparatus 32 outputs a wireless signal that is detectable by another device in order to complete a transaction, this aspect of the communication apparatus 32 can be considered to be a part of the output apparatus 28. Similarly, if the communication apparatus 32 receives a wireless signal from another device in order to complete a transaction, this aspect of the communication apparatus 32 can be considered to be a part of the input apparatus 24. Other variations will be apparent.

The mobile electronic device 4 can be said to include a touch-sensitive display in the form of visual display 36 that can be said to be a part of the output apparatus 28 and a touch screen overlay 40 overlying the visual display 36 and which can be said to be a part of the input apparatus 24. Moreover, the input apparatus 24 can include a physical or virtual keypad, and the output apparatus 28 can include a conventional visual display, lights, and the like without limitation.

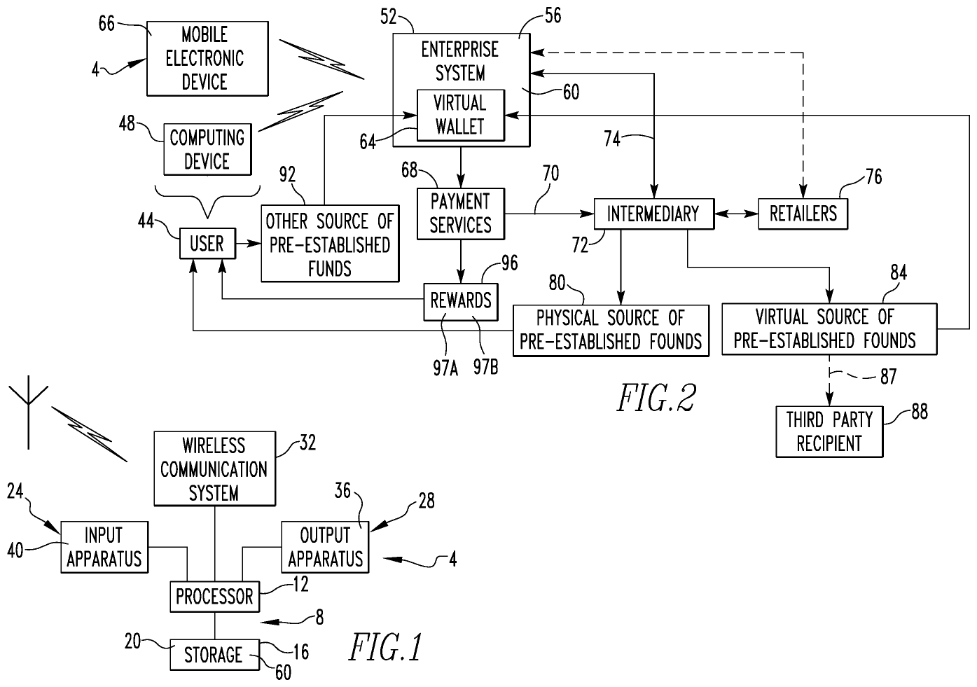

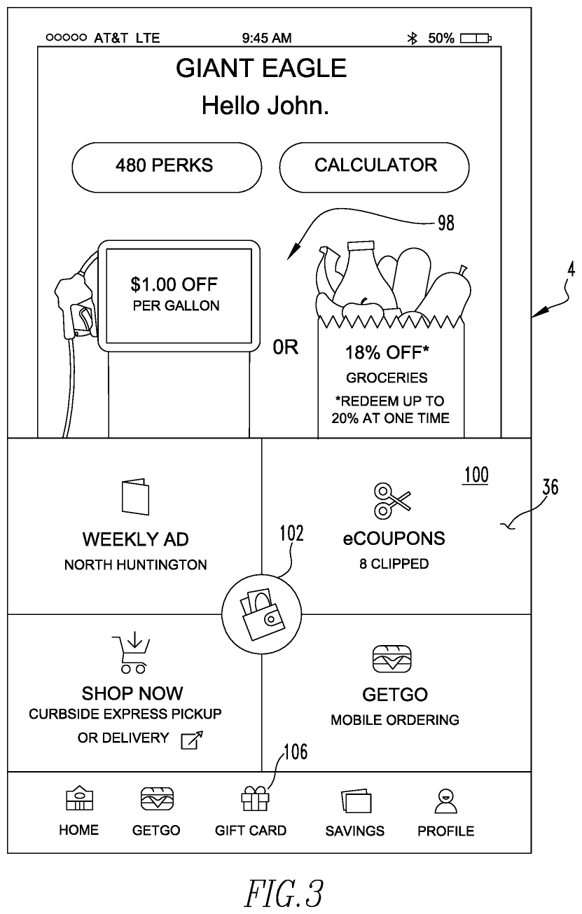

As can be understood from FIG. 2, the mobile electronic device 4 is operable by a user 44 who additionally and optionally may have access to another computing device 48 such as a desktop computer or the like that is separate from the mobile electronic device 4. The mobile electronic device 4 and the computing device 48 are capable of communication via a communications network with an enterprise system 52 which has a storage 56 and an Application Programming Interface (API) 60 that is stored in the storage 56 and that is executable on a processor of the enterprise system to cause the enterprise system 52 to perform certain operations. The enterprise system 52 is itself still another computing device. The enterprise system 52 further includes a virtual wallet 64 that is stored in the storage 56 and that is associated with an account that is owned by the user 44. It is understood that the user 44 is one of any number of users 44 that may have mobile electronic devices 4 and for whom an associated virtual wallet 64 exists in the storage 56. As will be set forth in greater detail below, the virtual wallet 64 has stored therein a set of identification information for each of the various sources of pre-established funds that are owned or controlled by the user 44, and it is further understood that each such user 44 will have created for him or her by the enterprise system 52 a corresponding virtual wallet 64 within which is stored the sets of identification information for all of the various sources of pre-established funds that are owned or controlled by such user. For example, the identification information can include the name of the business where the pre-established funds can be used, the balance of the funds that are available, and other pertinent information, by way of example and without limitation.

One of the routines 20 is in the form of a mobile app 66 that is stored in the storage 16 and that is executable on the processor 12 and which interfaces with the API 60 of the enterprise system 52. A similar app can be deployed on the computing device 48 that likewise can interface with the API 60. As will be set forth in greater detail below, the mobile app 66 provides to the user 44 an opportunity to purchase a source of pre-established funds in the exemplary form of a gift card which may be provided in any of a variety of formats. The user 44 can select the particular gift card that is desired to be purchased and the amount of funds which the gift card will represent, and the user 44 can additionally select the format of the gift card and can input the identity of the recipient. For instance, the recipient may be the user 44 himself or herself, or it may be a third party. While it is noted that gift cards are the exemplary sources of pre-established funds that are described and referenced herein, it is understood that any of a wide variety of other sources of pre-established funds can exist and can be used in association with the method that is described herein. As such, while the expression “gift card” and “source of pre-established funds” may be used interchangeably herein, it is understood that the sources of pre-established funds could in fact be in the form of gift cards or could in fact be in the form of any other type of pre-established funds that can be established.

In order for the user 44 to purchase such a gift card, the user will provide credit card information or will provide another form of payment, and the enterprise system 52 communicates such payment details to a payment services system 68. In the depicted exemplary embodiment, once payment for the gift card has been confirmed by the payment services system 68, an instruction is generated to the effect that the gift card should be created. In the depicted exemplary embodiment, the payment services system 68 is internal to the enterprise system 52, and thus the instruction to create the gift card can occur along a communications channel 70 from the payment services system 68 to an intermediary 72 that will be described in greater detail below. Alternatively, if the payment services system 68 is external to the enterprise system 52, the payment services system 68 may communicate back to the enterprise system 52 that the payment was accepted, and the enterprise system 52 may separately instruct the intermediary 72 via a communications channel 74 to create the gift card. The intermediary 72 is in communication with an issuing network and/or a number of retailers 76 who will redeem the sources of pre-established funds. FIG. 2 also depict in a dashed line a communications channel that is directly between the enterprise system 52 and a retailer 76, which can occur if the intermediary 72 is not used, and which would be used by the enterprise system 52 to directly instruct the retailer 76 to generate the gift card, by way of example.

In the depicted exemplary embodiment, the intermediary 72 communicates to an issuing network and/or to one of the retailers 76 the details for the gift card that was just created by the intermediary 72. For instance, the gift card that was just created has a set of identification information associated with it. In the depicted exemplary embodiment, the set of identification information includes an identity of the particular retailer 76 who will redeem the pre-established funds, a card number for the gift card, and a PIN for the card. In other embodiments, the set of identification information may not include a PIN and/or may include other information such as the amount of funds and/or other information. The intermediary 72 will forward to the specific retailer 76 that was specified in the set of identification information the card number and PIN (or whatever information the set of identification information included) for the card that was just created.

The intermediary 72 additionally communicates the source of pre-established funds, i.e., the gift card by way of example, to whoever is the recipient. For instance, the source of pre-established funds might have been specified by the user 44 to be in a physical form, i.e., as a physical card or sheet of paper with the identity of the retailer 76, a card number, and the PIN. The physical source of pre-established funds 80 might additionally include a barcode or other indicium that can be detected by the identified retailer as part of a monetary transaction, and the pre-established funds associated therewith can be consumed, in whole or in part, in order to perform at least a portion of the monetary transaction or other transaction.

In one depicted exemplary embodiment, the user 44 has specified that the physical source of pre-established funds 80 would be sent to the user 44 himself or herself, such as via post or courier services. The user 44 alternatively could have directed that the physical source of pre-established funds 80 be sent to another recipient, such as to make a gift of the physical source of pre-established funds 80, by way of example.

Once the user 44 receives the physical source of pre-established funds 80, the user 44 can take the physical source of pre-established funds 80 in its physical form, i.e., in its card or paper stock form, to a retailer, and the retailer can scan or otherwise detect the barcode or other indicia in order to cause the pre-established funds that are associated with the physical source of pre-established funds 80 to be used to perform a monetary transaction or other transaction with that particular retailer 76. As will be set forth in further detail below, however, the user 44, upon receipt of the physical source of pre-established funds 80 can advantageously add that physical source of pre-established funds 80 to the virtual wallet that is associated with the account of the user 44.

Alternatively, the user 44 may have specified that what was desired was a virtual source of pre-established funds 84, rather than a physical one. Such a virtual source of pre-established funds 84 is created by the intermediary 72 in the depicted exemplary embodiment and is then forwarded electronically to a recipient or is forwarded electronically for the benefit of the recipient. In the depicted exemplary embodiment, the virtual source of pre-established funds 84 is electronically transferred to the virtual wallet 64 that is associated with the account of the user 44, meaning that the user 44 specified that the gift card that was being purchased was to be generated in virtual, electronic form, and that it was to be forwarded to the user 44 rather than to another party. This electronic transfer of the virtual source of pre-established funds 84 is depicted in FIG. 2 as being directed to the virtual wallet 64 of the user 44. It is noted, however, in dashed lines 87 in FIG. 2 that the user 44 alternatively could have requested that the virtual source of pre-established funds 84 be sent electronically to a third party recipient 88.

It is also understood that the intermediary 72 that is depicted in FIG. 2 is entirely optional. That is, and as suggested elsewhere herein, the enterprise system 52 and/or the payment services system 68 could be established to communicate directly with each of the various retailers 76, and whichever retailer 76 is contacted with an order for a gift card could then directly generate the physical source of pre-established funds 80 and/or the virtual source of pre-established funds 84. In the depicted exemplary embodiment, the enterprise system 52 and the payment services system 68 interface directly with the intermediary 72 rather than directly with the retailers 76 because the retailers 76 in the depicted exemplary embodiment are of sufficient quantity that the presence of the intermediary 72 is practical from a financial standpoint and from an operational standpoint. It is understood, however, that the intermediary 72 that is depicted in the exemplary embodiment is entirely optional depending up the needs of the particular application.

FIG. 2 further depicts the user 44 having another source of pre-established funds 92 which may be, for example, a gift card that was purchased at a retail location or was received from another person, etc. While the user 44 could retain the other source of pre-established funds 92 and take it in its physical form to a retailer and redeem the pre-established funds associated therewith, the user 44 can instead advantageously add it to the virtual wallet 64 that is associated with the account of the user 44. As will be set forth in greater detail below, the mobile app 66 will generate and visually output a dialog screen 100 on the visual display 36 whereby the user 44 can enter the name of the retailer of the other source of pre-established funds 92 along with the card number and the PIN (i.e., the set of identification information of the other source of pre-established funds 92), and the mobile app 66 will communicate this information to the API 60, which will instruct the storage in the virtual wallet 64 of the set of identification information for the other source of pre-established funds 92. In such a fashion, the other source of pre-established funds 92 will advantageously be stored in the virtual wallet 64 that is associated with the account of the user 64. As such, the user 44 can thereafter employ the mobile electronic device 4 to access the pre-established funds that are associated with the other source of pre-established funds 92 in order to use such funds to complete a monetary transaction or other transaction with the retailer that was identified in the set of identification information and that was entered by the user 44. In a similar fashion, if the user 44 had specified that the gift card that was being purchased in FIG. 2 was to be delivered as the physical source of pre-established funds 80 and was to be delivered to the user 44, the user could perform the same operations with the mobile app 66 interfacing with the API 60 to save in the virtual wallet 64 that is associated with the account of the user 44 the set of identification information for the physical source of pre-established funds 80, i.e., the name of the retailer 76, the card number, and the PIN, by way of example.

Advantageously, the payment services system 68 additionally triggers the generation of a reward that is then stored within a set of rewards 96 and whose generation is responsive to the user 44 having purchased the gift card via the enterprise system 52. That is, the enterprise that operates the enterprise system 52 knows that a user who intends to enter into a transaction with a given retailer 76 could simply use a credit card or cash or other source of funds to purchase goods and services from the given retailer 76. However, since the enterprise that operates the enterprise system 52 makes a commission from the sale of gift cards and is willing to share with the user 44 a portion of that commission in the form of a reward being added to the set of rewards 96, the user 44 is encouraged to purchase gift cards through the enterprise system 52 and accumulate rewards that are usable with the given retailer 76 rather than spend money directly with the given retailer 76 without an additional reward. The user 44 can then use the rewards that are stored in the set of rewards 96 as the user 44 wishes within the construct of one or more rewards programs.

The set of rewards 96 can include one or more reward banks, and two such reward banks are indicted at the numerals 97A and 97B in FIG. 2 as being stored as a part of the set of rewards 96. The reward banks may be collectively or individually referred to herein with the numeral 97. Each reward bank 97 might be associated with a particular enterprise, for instance. Each reward bank 97 has stored therein a set of reward data that is reflective of, for example, a cumulative reward that usable by the user 44 in any of a number of predetermined fashions that have been pre-established by the enterprise with which the reward bank 97 is associated. In the depicted exemplary embodiment, the reward bank 97A of FIG. 3 is associated with the enterprise that operates the enterprise system 52 and is named GIANT EAGLE. More particularly, the reward bank 97A includes a cumulative reward 98 that is depicted in FIG. 3 as including either a $1.00 discount per gallon of gasoline purchased or 18% off groceries purchased. In the depicted exemplary embodiment, this cumulative reward 98 is the cumulative result of a number rewards that have each been successive added by the payment services 68 to the reward bank 97A responsive to, for instance, various purchases of sources of pre-established funds 92 from the enterprise that is associated with the reward bank 97A or other actions that have been pre-defined by the enterprise.

It is understood that the set of rewards 96 can have stored therein additional reward banks 97 that are associated with other enterprises, such as the reward bank 97B. For example, a promotion might exist wherein a purchase of a source of pre-established funds 92 from the enterprise that is associated with the reward bank 97A will result in both a first reward being added to the reward bank 97A as well as a second reward being added to the reward bank 97B. For instance, the reward bank 97B might be for a retailing enterprise having a name such as MISSISSIPPI, and the reward that is stored in the reward bank 97B could be used in making purchases or conducting other transactions with MISSISSIPPI. Still alternatively, and by way of further example, MISSISSIPPI might deploy its own mobile app that is executable on the mobile electronic device 4. In such a situation, this separate mobile app might still be cooperable with the enterprise system 52 and be cooperable with the same virtual wallet 64, or it is possible that a separate virtual wallet might be employed in the context of the separate mobile app. In such a situation, the enterprise system 52 would be in the nature of an environment wherein various enterprises could deploy various mobile apps for use in purchasing and managing various sources of pre-established funds 92 and corresponding reward banks, each of which may or may not be cooperable with one another to, for instance, combine rewards or otherwise leverage financial incentives. In such a situation, the virtual wallet 64 potentially could become something of a universal virtual wallet if multiple entities such as GIANT EAGLE and MISSISSIPPI each add to the same virtual wallet 64 various sources of pre-established funds 92, for example. That is, when a source of pre-established funds 92 is purchased through the GIANT EAGLE mobile app 66, the GIANT EAGLE entity adds to the virtual wallet 64 that source of pre-established funds 92 and stores an incremental reward in the reward bank 97A, and when another source of pre-established funds 92 is purchased through the MISSISSIPPI mobile app, the MISSISSIPPI entity adds to the virtual wallet 64 the other source of pre-established funds 92 and stores an incremental reward in the reward bank 97B, all of which is available for use on the mobile electronic device 4.

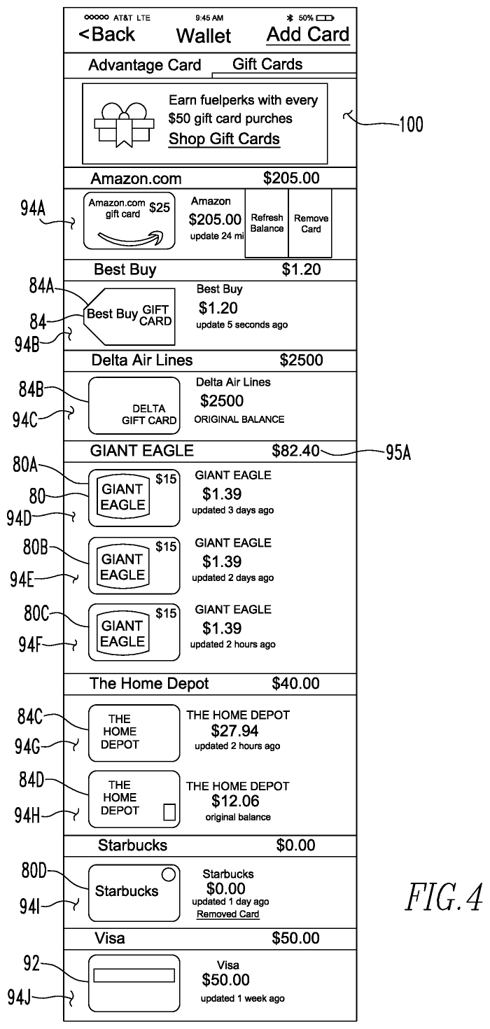

As can be seen in FIG. 3, the mobile app 66 executed by the processor apparatus 8 results in a dialog screen 100 being output on the visual display 36 of the mobile electronic device 4. Among other things, the dialog screen 100 includes a virtual wallet button 102 and a gift card button 106. If the virtual wallet button 102 is actuated, such as by pressing on the visual display 36 atop the virtual wallet button 102 to provide a selection input to the touch screen overlay 40, the contents of the virtual wallet 64 are visually output on the visual display 36, as in FIG. 4. That is, the virtual wallet 64 has stored therein a set of identification information for each source of pre-established funds that has been added to the virtual wallet 64. For instance, the sources of pre-established funds might include one or more physical sources of pre-established funds 80 that have been added manually by the user 44, and/or they may include one or more virtual sources of pre-established funds 84 that have been added manually by the user 44 or that may have been automatically added the virtual wallet 64 by the enterprise system 52.

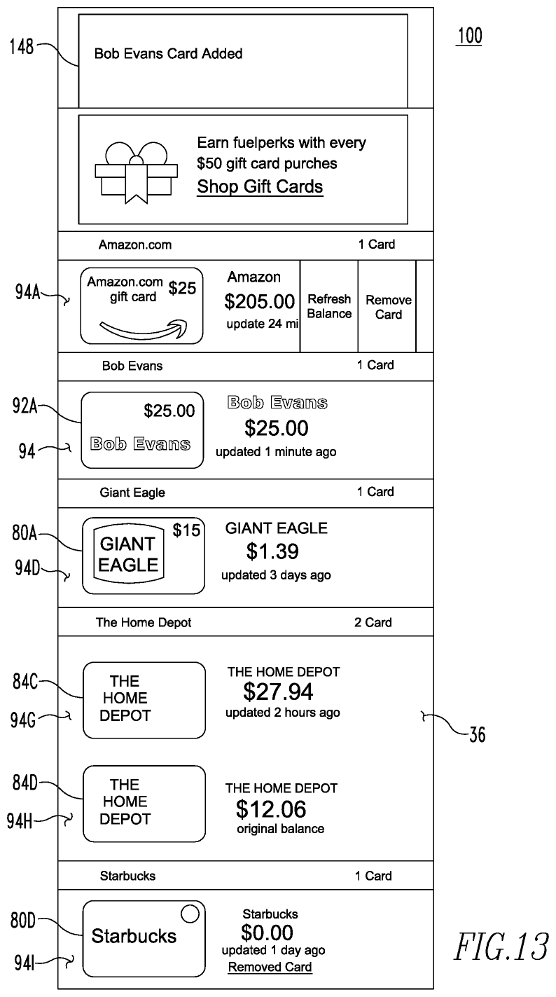

It is expressly noted that the virtual source of pre-established funds 84 that was indicated in FIG. 2 is one of any of a number of virtual sources of pre-established funds that are indicted elsewhere herein at the numerals 84A, 84B, 84C, 84D, 84E, 84F, and the like, all of which may be collectively or individually referred to herein with the numeral 84. The same can be said of the physical source of pre-established funds 80 that was indicated generally in FIG. 2, meaning that it can refer to any of a wide variety of physical sources of pre-established funds that may be indicated at the numerals 80A, 80B, 80C, 80D, etc., and which may be collectively or individually referred to herein with the numeral 80. Likewise, the other source of pre-established funds 92 that was entered by the user 44, as depicted in FIG. 2, is also indicated in FIG. 4 as having been added to the virtual wallet 64 and as being output on the visual display 36 as being selectable and available for use in a transaction. The other source of pre-established funds 92 is one of any number of other sources of pre-established funds, such as the other source of pre-established funds 92A (FIG. 13) that is described elsewhere herein, and all of which may be collectively or individually referred to herein with the numeral 92.

That is, and as can be seen in FIG. 4, the visual display 36 of the mobile electronic device 4 has output thereon a visual representation that corresponds with each of the sources of pre-established funds that are stored in the virtual wallet 64. The visual representations are indicated at the numerals 94A, 94B, 94C, 94D, 94E, 94F, 94G, 94H, 94I, and 94J, and which may be collectively or individually referred to herein with the numeral 94. Each such visual representation 94 in the depicted exemplary embodiment incudes some artwork that depicts the retailer 76 where the pre-established funds can be redeemed and additionally includes the textual name of the retailer 76 as well as the balance of pre-established funds that remain in association with each such source of pre-established funds. The various sources of pre-established funds 84 can be depicted on the visual display 36 in any of a variety of fashions. In the depicted exemplary embodiment, the sources of pre-established funds 84 are grouped by retailer, and additional visual objects depict the total amounts of funds that are available for each retailer when multiple gift cards are owned for the same retailer 76. In certain circumstances, and depending upon the quantity of sources of pre-established funds 84 that are stored in the virtual wallet 64 for a particular retailer, fewer than all of the individual sources of pre-established funds 84 might be output on the visual display 36. An example of this is depicted in FIG. 4 wherein fewer than all of the sources of pre-established funds 84 for the retailer “GIANT EAGLE” are output on the visual display 36, since only three such sources of pre-established funds 84 are being visually depicted in FIG. 4, yet the visual display 36 still visually depicts with an additional visual object 95A that the amount $84.20 as being the total amount available for “GIANT EAGLE” even if fewer than all of the sources of pre-established funds 84 are simultaneously output on the visual display 36.

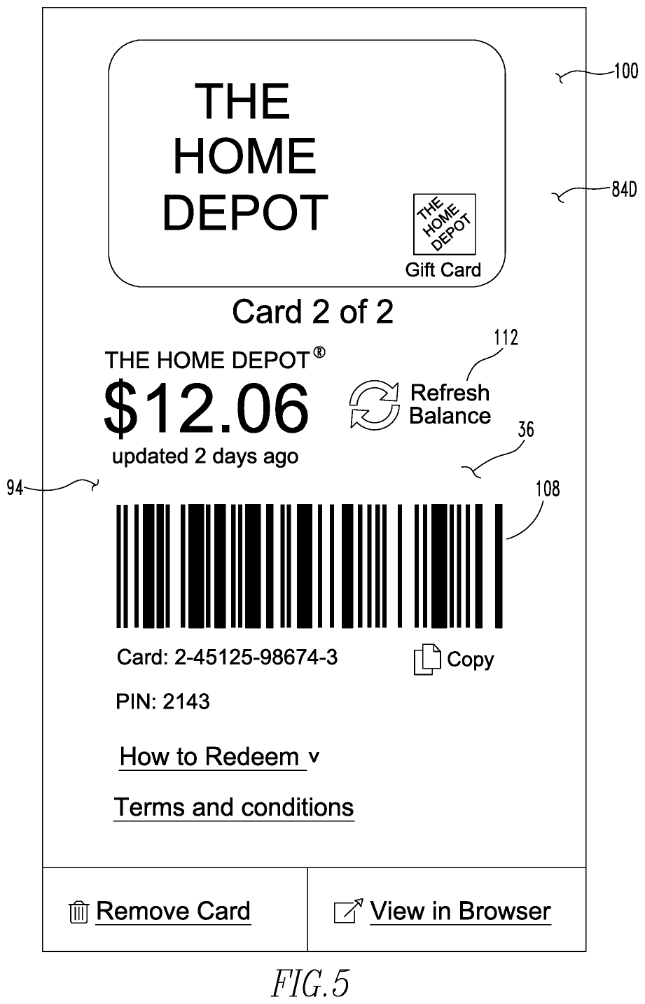

If any of the sources of pre-established funds 84 is desired to be employed by the user 44 in order to enable the performance of a monetary or other transaction, the user simply inputs a pressing selection input on the touch screen overlay 40 at a location thereon atop the visual representation 94 of whichever source of pre-established funds 84 is desired to be used, such as the source of pre-established funds 84D in the depicted exemplary embodiment. This results in the mobile app 66 outputting the screen depicted generally in FIG. 5 wherein the visual representation 94 of the selected source of pre-established funds 84D is enlarged, and additionally the set of identification information is displayed as a part of the visual representation 94, specifically including the card number and the PIN. Additionally, the visual representation 94 includes an indicium in the form of a barcode 108 that is depicted on the visual display 36 and which is generated by the mobile app 66 on the mobile electronic device 4. The barcode 108, being visually depicted on the visual display 36, enables the barcode 108 to be detected, such as by being scanned by another device such as a barcode reader of a point-of-sale retail system in order to enable the performance of at least a portion of a monetary transaction or other transaction. Other types of indicia may be provided, such as QR codes, non-visual indicia such as RF signals, etc., and without limitation.

The barcode 108 that is depicted on the visual display 36 is therefore scanned by the appropriate retailer 76 in precisely the same way that the retailer 76 would have scanned a barcode of a physical gift card, thereby enabling a monetary transaction or other transaction to occur by using the pre-established funds associated with the selected gift card. As can be seen in FIG. 5, the visual display 36 additionally outputs another button 112 which includes the text “Refresh Balance” and that can be characterized as a <RESET> button. If this button is actuated by a pressing selection input on the touch screen overlay 40, a query is initiated on the mobile electronic device 4 and is forwarded to the API 60 (such as by communicating the set of identification information for the source of pre-established funds, i.e., the identity of the retailer 76, the card number, and the PIN, by way of example). In the depicted exemplary embodiment, the API 60 then sends an inquiry to the intermediary 72 asking it to provide an update of the balance of funds that are remaining with the selected gift card. The intermediary 72 contacts the particular retailer 76 that is associated with that particular selected source of pre-established funds, obtains therefrom the balance of funds remaining, and returns the balance to the enterprise system 52, which returns it to the mobile electronic device 4. The mobile electronic device 4 then updates the visual representation 94 on the visual display 36 to reflect the current balance of pre-established funds for that gift card. Once some or all of the pre-established funds are used to complete at least in whole or in part a monetary transaction or other transaction, the remaining balance of pre-established funds is then stored by the retailer 76, and the remaining balance may also be automatically updated on the visual display 36 through a balance inquiry operation as set forth above or through other operations that may occur.

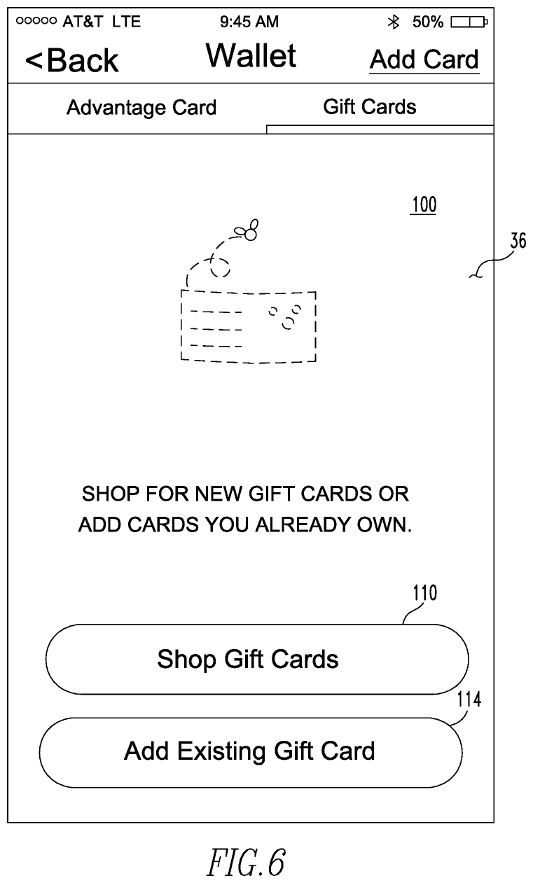

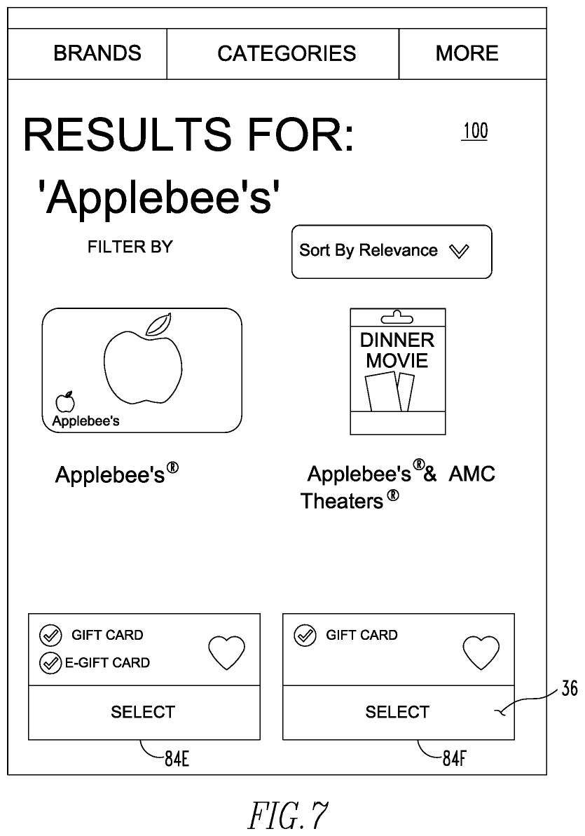

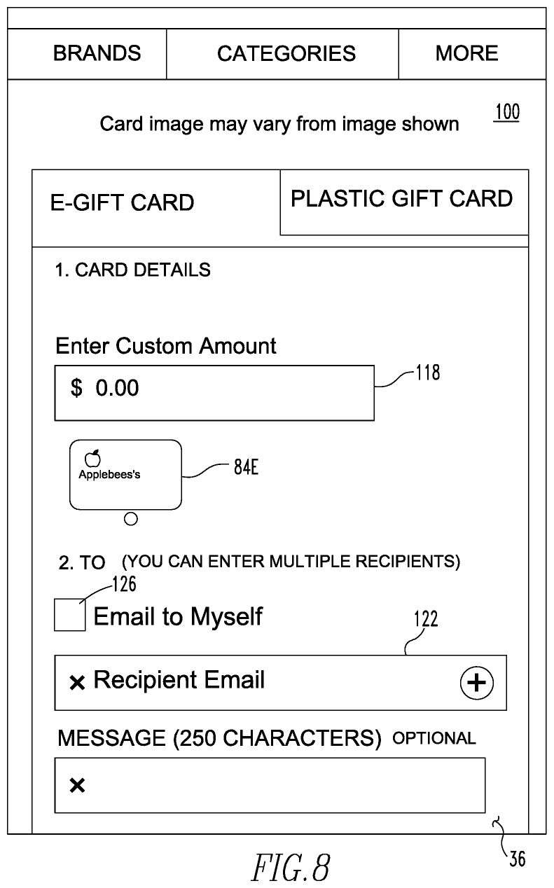

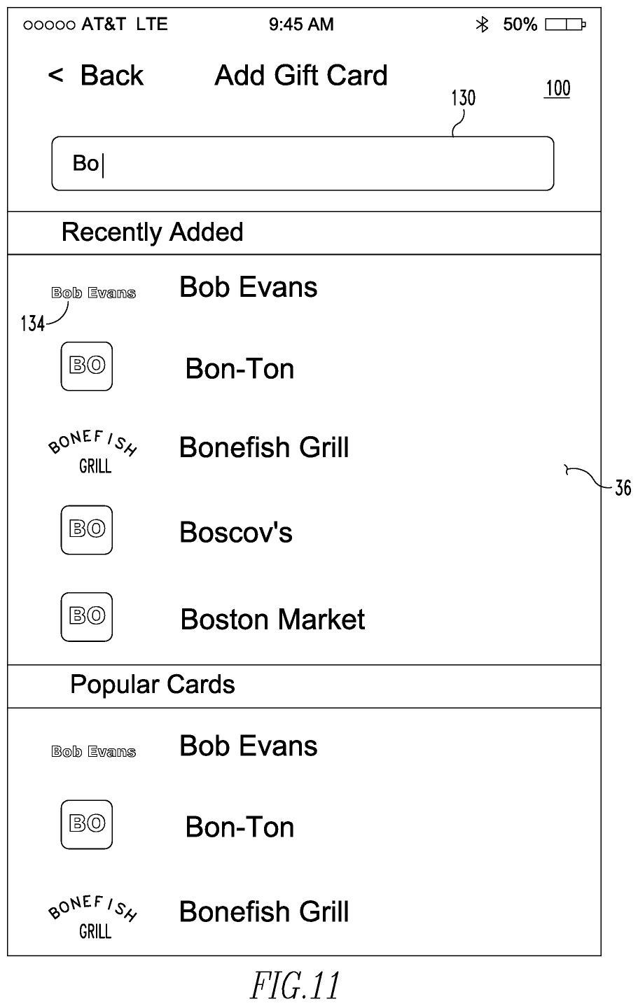

If the user actuates the gift card button 106 of FIG. 3, another visual dialog screen 100, such as which is depicted in FIG. 6, is output on the visual display 36. FIG. 6 includes a SHOP GIFT CARDS button 110 which, if actuated, enables the user 44 to shop for new gift cards. The visual dialog screen 100 of FIG. 6 further includes an ADD EXISTING GIFT CARD button 114 which, if actuated, enables a user to add another source of pro-established funds 92A (FIG. 13) to the user's virtual wallet 64, as will be described in conjunction with FIGS. 11-13, and such as was done in association with the numeral 92 in FIG. 2 and the accompanying text presented herein.

If the user 44 actuates the SHOP GIFT CARDS button 110, the user 44 is given a search dialog box that enables the user 44 to enter text that is representative of the name of the retailer 76 whose gift card the user 44 desires to purchase. The search engine that is offered by the mobile app 66 interfaces with the API 60 which, in turn, interfaces with the intermediary 72 which stores in a storage a set of gift card products that are available. In the accompanying example the user is searching for a gift card for the retailer known as “Applebee's” and has already typed that search term into a search window which, after a call to the intermediary 72, returns to the mobile electronic device 4 the products that are depicted on the visual display 36 in FIG. 7. Specifically, two possible choices are indicated at the numerals 84E and 84F. If the user selects 84E, for example, the mobile electronic device 4 outputs on its visual display 36 the visual output that is depicted generally in FIG. 8.

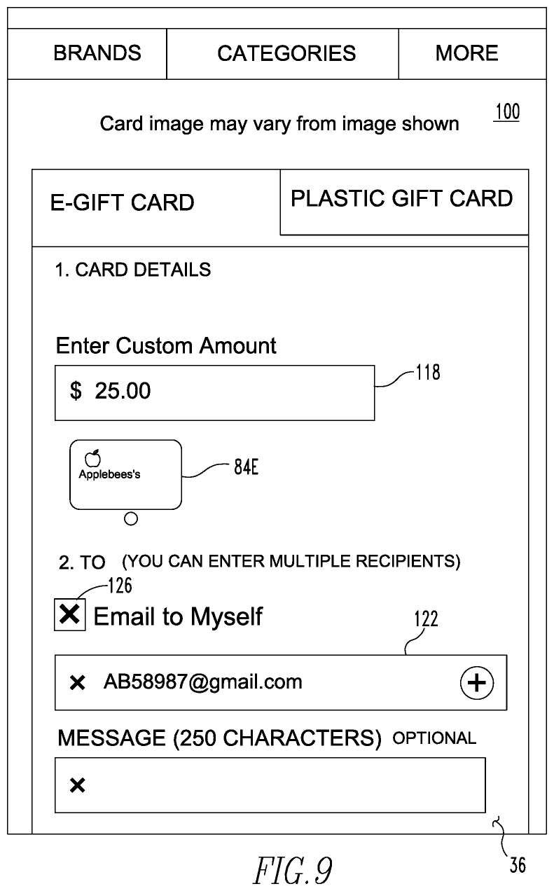

Specifically, the “Applebee's” gift card 84E is being offered in a separate dialog screen 100 in FIG. 8 which enables the user to enter an amount of pre-established funds with which the gift card 84E will be associated, such as with an amount window 118. Also provided in FIG. 8 is an email address window 122 which enables the user 44 to enter the email address of the intended recipient. If the intended recipient is the user 44, the user 44 can alternatively simply check the checkbox 126 which will automatically populate in the email address window 122 the email address that is associated with the user 44. This is indicated in FIG. 9 wherein the amount of $25 has additionally been entered into the amount window 118.

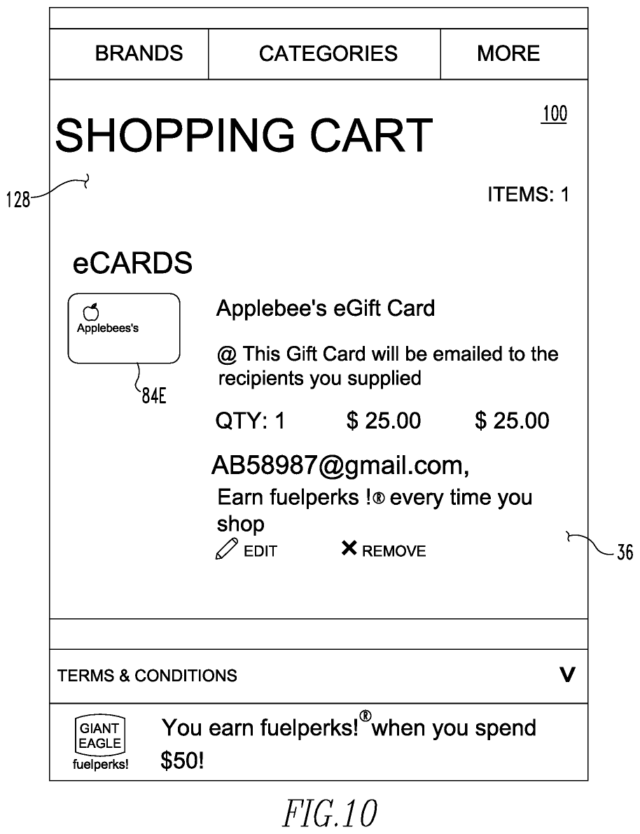

After all of the relevant information has been entered into the dialog screen 100, as in FIG. 9, the user can actuate another button to add the card, in its current form, to a “SHOPPING CART” 128, as in FIG. 10. The “SHOPPING CART” is visually depicted in a dialog screen 100 on the visual display 36 of FIG. 10 as including the source of pre-established funds 84E as selected by the user, in the amount chosen by the user, and being delivered to the email address selected by the user, i.e., that of the user himself or herself. The user 44 then enters a separate payment dialog wherein the user enters credit card information or other appropriate information to complete the purchase of the source of pre-established funds 84E. Since the source of pre-established funds 84E is being delivered to the user herself or himself, the enterprise system 52 automatically adds the source of pre-established funds 84E which was just purchased to the virtual wallet 64 that is associated with the account of the user 44. If the user were to thereafter actuate the wallet button 102 of FIG. 3, the source of pre-established funds 84E would be listed among the other sources of pre-established funds 84 as being available for use. It thus can be seen that the user 44 can be physically situated anywhere, including at the location of the retailer 76, can easily purchase the source of pre-established funds 84E using the mobile app 66, and can instantaneously or nearly so begin to use the newly purchased source of pre-established funds 84E in association with the retailer 76.

As noted above, the user can add into the virtual wallet 64 the other source of pre-established funds 92A (FIG. 13) that is already in the possession of the user 44, as is depicted generally in FIGS. 11-13. Specifically, FIG. 11 depicts a dialog screen 100 having a search window 130 into which the user can enter the name of the retailer whose name is printed on the other source of pre-established funds 92A. In this case, the gift card is from a retailer 76 known as “Bob Evans”, and the user has begun to type “Bo” into the search window 130 on the visual display 36. In so doing, the mobile electronic device 4 interfaces with the API 60 and, in turn, with the product database of the intermediary 72. The intermediary returns and causes the outputting on the visual display 36 of the various retailers 76 whose names begin with “Bo”. Alternatively, the intermediary 72 may optionally generate a copy of the product catalog on a regular basis, e.g., nightly by way of example, and the copy can be uploaded to the enterprise system 52 and stored in the storage 56. In such a situation, when the search occurs within the mobile app 66, the API 60 will instead communicate with the copy of the product catalog that stored in the storage 56 of the enterprise system 52 rather than communicating with the intermediary 72.

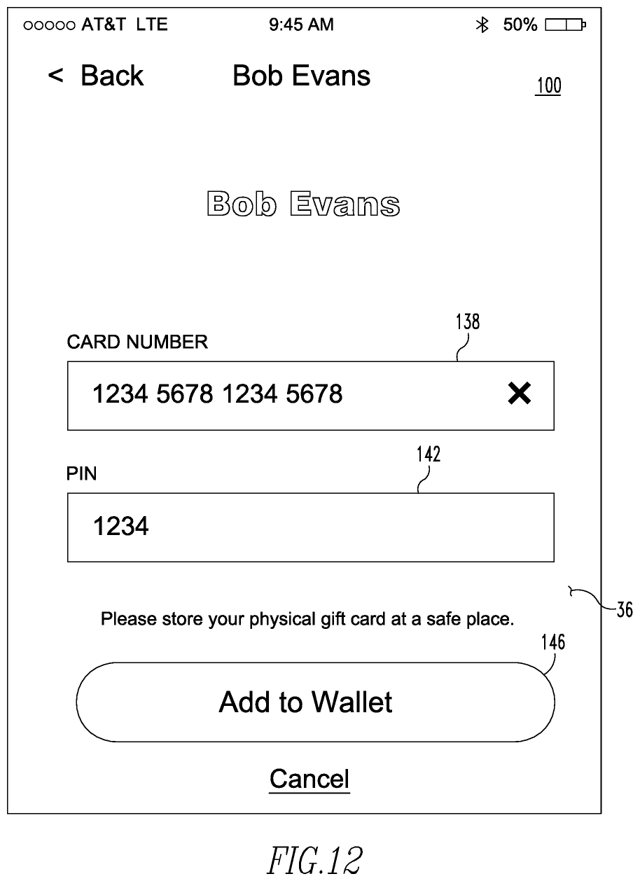

Once the user sees the desired retailer 76 “Bob Evans”, as at the visual representation of a button depicted at the numeral 134, the user can select the retailer button 134 by providing a press actuation input on the touch screen overlay 40 at a location thereon atop the retailer button 134. This results in a dialog screen that is depicted generally at the numeral 100 in FIG. 12 wherein the user is enabled to manually enter a series of alphanumeric inputs or other inputs using a keypad of the input apparatus 24 a card number and a PIN into a card number field 138 and a PIN field 142. Once the user has entered the relevant information into the relevant fields, as in FIG. 12, the user can actuate the “ADD TO WALLET” button 146 which then communicates to the enterprise system 52 the set of identification information for the other source of pre-established funds 92A, namely the identity of the retailer 76 “Bob Evans”, the card number as indicated in the card number field 138, and PIN as indicated in the PIN field 142, of the gift card that is desired to be entered into the user's virtual wallet 64. The enterprise system 52 thus adds the set of identification information to the virtual wallet 64, and a notification 148 is output on the visual display 36, as is indicated in FIG. 13. FIG. 13 additionally depicts that the other source of pre-established funds 92A has been added to the virtual wallet 64 by depicting a visual representation 94 of the gift card 92A that corresponds with that particular other source of pre-established funds 92A. Such visual representation 94 of the other source of pre-established funds 92A is output on the visual display 36 in conjunction with the visual representations 94 of the various other sources of pre-established funds 80 and 84 that are also stored in the user's virtual wallet 64.

It thus can be seen that the various sources of pre-established funds 80, 84, 92, etc., whether they be virtual or plastic, and whether purchased by the user 44 or purchased by another person and given to the user 44, can all be stored in the virtual wallet 64 that is associated with the user 44. The system enables the rapid purchasing of sources of pre-established funds for essentially immediate use, which enables a user who is situated at a retail location and who wishes to purchase a gift card for use at the retailer 76 to do so. Doing so enables the user 44 to obtain the set of rewards 96 that are automatically provided by the enterprise for purchasing gift cards through the enterprise system 52.

It is also noted that geo-fencing can be used to perform other functions, such as functions in association with the virtual wallet 64. For instance, the enterprise system 52 or the mobile app 66 or both, by way of example, may employ GPS or other location data to determine that the user 44 is situated at the physical location of a retailer 76 for whom a gift card is stored in the virtual wallet 64. The enterprise system 54 may responsively push to the mobile electronic device 4 a notification reminding the user 44 that the user 44 has in the virtual wallet 64 a gift card that can be used at the retailer where the user 44 is situated. The push message might include other information such as the remaining balance of pre-established funds that are available for use, an inducement to purchase additional funds, and any other promotional material or offerings that the retailer 76 or the enterprise who operates the enterprise system 52 may find desirable. This both facilitates the use of the sources of pre-established funds 84 and promotes the purchasing of additional sources of pre-established funds for that specific retailer 76 and for other retailers.

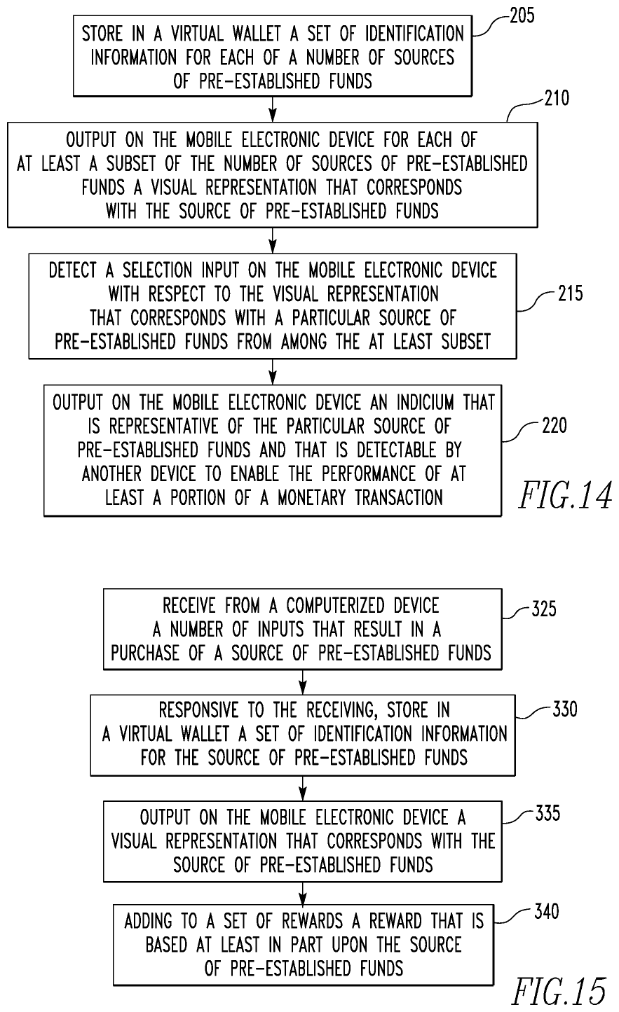

As can be seen in FIG. 14, an improved method in accordance with the disclosed and claimed concept can be said to begin at the numeral 205 wherein a set of identification information is stored in the virtual wallet 64 for each of a number of sources of pre-established funds, such as gift cards, by way of example and without limitation, that are owned by the user 44. Processing can be said to continue, as at 210, where the mobile electronic device 4 outputs on its visual display 36 for each of at least a subset of the sources of pre-established funds 80, 84, 92 a visual representation 94 that corresponds with the source of pre-established funds 80, 84, 92. This was depicted, for instance, in FIG. 4, and elsewhere herein. This enables the user 44 to be apprised of the various pre-established funds that exist in the virtual wallet 64 and enables the user 44 to select a particular gift card for use.

Processing can be said to continue, as at 215, where a selection input on the touch screen overlay 40 is detected with respect to one of the visual representations 94, i.e., one that corresponds with a particular source of pre-established funds 80, 84, 92 that is desired to be used by the user 44. In the depicted exemplary embodiment, the selection input was detected with respect to the source of pre-established funds 84D. Processing then continues, as at 220, where the mobile electronic device 4 outputs on its visual display 36 an indicium, such as the barcode 108 that was depicted in FIG. 5. The barcode 108 advantageously is visually depicted on the visual display 36 and it is detectable by another device, such as a barcode scanner of a point-of-sale retail system, in order to enable the performance of at least a portion of a monetary transaction or other transaction. The retailer 76 that completed the transaction then updates its own records with the remaining balance of the source of pre-established funds.

As can be understood from FIG. 15, another improved method in accordance with the disclosed and claimed concept can be said to begin, as at the numeral 325, with the receiving from a computerized device of a number of inputs that result in a purchase of a source of pre-established funds 80, 84, 92, by way of example. The computerized device could be the mobile electronic device 4 or other computing device such as the computing device 48 or other computing device, by way of example. Processing continues, as at 330, with the storing in the virtual wallet 64 of a set of identification information for the source of pre-established funds 80, 84, 92, by way of example. Such storing is responsive to the receiving of the number of inputs, as at 325.

Processing then continues, as at 335, with the outputting on the mobile electronic device 4 of a visual representation 94 that corresponds with the source of pre-established funds 80, 84, 92, by way of example. Processing then continues, as at 340, with the adding to a set of rewards 96 of a reward that is based at least in part upon the source of pre-established funds 80, 84, 92 that was purchased at 325. The adding of the reward can be made to a reward bank 97 that potentially is one of any number of reward banks that may be a part of the set of rewards 96. It is also understood that the adding of the reward is an incremental addition to the set of rewards 96, and that the cumulative rewards in, for instance, a reward bank 97, can be employed for some purpose that is beneficial to the user 44.

It thus can be seen that the improved method and system enable the purchase and use of gift cards, which is advantageous. Further advantageously, the system is sufficiently simple to operate that the user 44 is encouraged to make use of such system by the set of rewards 96 that are offered by the enterprise that operates the enterprise system 52. Geo-fencing can be employed to provide further encouragement to use the improved method and system. Other benefits will be apparent.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A method of providing on a mobile electronic device access to a number of sources of pre-established funds, the mobile electronic device having a processor apparatus that includes a processor and a storage, an input apparatus that is structured to provide input signals to the processor apparatus, and an output apparatus that is structured to receive output signals from the processor apparatus, the method comprising:
storing in a virtual wallet a set of identification information for each source of pre-established funds of the number of sources of pre-established funds;
outputting on the output apparatus for each source of pre-established funds of at least a subset of the number of sources of pre-established funds a visual representation that corresponds with the source of pre-established funds;
detecting on the input apparatus a selection input with respect to the visual representation that corresponds with a particular source of pre-established funds from among the at least subset; and
outputting an indicium that is representative of the particular source of pre-established funds and that is detectable by another device to enable the performance of at least a portion of a monetary transaction.

2. The method of claim 1, further comprising outputting as at least a part of the visual representation that corresponds with the source of pre-established funds a visual identification of the source of pre-established funds.

3. The method of claim 2, further comprising:
obtaining from a data source a fund balance that is available as to each source of pre-established funds of the at least subset; and
outputting as another part of the visual representation that corresponds with the source of pre-established funds a numerical representation of the fund balance.

4. The method of claim 3, further comprising outputting as a further part of the visual representation that corresponds with the source of pre-established funds a representation of at least one of:
an amount of time that has elapsed since the fund balance was obtained;
a time at which the fund balance was obtained; and
a date on which the fund balance was obtained.

5. The method of claim 3, further comprising:
outputting a <RESET> visual object;
detecting an actuation input on the mobile electronic device with respect to the <RESET> visual object;
responsive to the detecting, obtaining from the data source an updated version of the fund balance for at least one source of pre-established funds from among the at least subset; and
replacing the numerical representation of the fund balance for the at least one source of pre-established funds with a numerical representation of the updated version of the fund balance.

6. The method of claim 1, further comprising:
receiving from a computerized device an input of a set of identification information for an additional source of pre-established funds, the computerized device being one of the mobile electronic device and another electronic device;
responsive to the receiving, storing in the virtual wallet the set of identification information for the additional source of pre-established funds; and
outputting on the mobile electronic device as a part of the at least subset a visual representation that corresponds with the additional source of pre-established funds.

7. The method of claim 6 further comprising receiving from the computerized device as the set of identification information a series of inputs detected on the input apparatus of the mobile electronic device.

8. The method of claim 6 further comprising adding to a set of rewards a reward that is based at least in part upon the additional source of pre-established funds, the set of awards being associated with at least one of the virtual wallet and an owner of the virtual wallet.

9. The method of claim 1, further comprising:
determining that the mobile electronic device is situated at or within a predetermined proximity of a predetermined location;
responsive to the determining, communicating to the mobile electronic device at least one of:
a notification that at least one source of pre-established funds of the number of sources of pre-established funds is available for use at the predetermined location, and
a suggestion to purchase an additional source of pre-established funds that is usable at the predetermined location.

10. The method of claim 1 wherein the storing in the virtual wallet of a set of identification information for each source of pre-established funds comprises storing the set of identification information for each source of pre-established funds in a data source that is in wireless communication with the mobile electronic device.

11. A mobile electronic device that is structured to have access to a virtual wallet, the virtual wallet having stored therein a set of identification information for each of a number of sources of pre-established funds, the mobile electronic device comprising:
a processor apparatus comprising a processor and a storage;
an input apparatus structured to provide input signals to the processor apparatus;
an output apparatus structured to receive output signals from the processor apparatus;
the storage having stored therein a number of instructions which, when executed on the processor, are structured to cause the mobile electronic device to perform operations comprising:
outputting on the output apparatus for each source of pre-established funds of at least a subset of the number of sources of pre-established funds a visual representation that corresponds with the source of pre-established funds;
detecting on the input apparatus a selection input with respect to the visual representation that corresponds with a particular source of pre-established funds from among the at least subset; and
outputting an indicium that is representative of the particular source of pre-established funds and that is detectable by another device to enable the performance of at least a portion of a monetary transaction.

12. The mobile electronic device of claim 11 wherein the operations further comprise outputting as at least a part of the visual representation that corresponds with the source of pre-established funds a visual identification of the source of pre-established funds.

13. The mobile electronic device of claim 12 wherein the operations further comprise:
obtaining from a data source a fund balance that is available as to each source of pre-established funds of the at least subset; and
outputting as another part of the visual representation that corresponds with the source of pre-established funds a numerical representation of the fund balance.

14. The mobile electronic device of claim 13 wherein the operations further comprise outputting as a further part of the visual representation that corresponds with the source of pre-established funds a representation of at least one of:
an amount of time that has elapsed since the fund balance was obtained;
a time at which the fund balance was obtained; and
a date on which the fund balance was obtained.

15. The mobile electronic device of claim 13 wherein the operations further comprise:
outputting a <RESET> visual object;
detecting an actuation input on the mobile electronic device with respect to the <RESET> visual object;
responsive to the detecting, obtaining from the data source an updated version of the fund balance for at least one source of pre-established funds from among the at least subset; and
replacing the numerical representation of the fund balance for the at least one source of pre-established funds with a numerical representation of the updated version of the fund balance.

16. The mobile electronic device of claim 11 wherein the operations further comprise:
receiving from a computerized device an input of a set of identification information for an additional source of pre-established funds, the computerized device being one of the mobile electronic device and another electronic device;
responsive to the receiving, storing in the virtual wallet the set of identification information for the additional source of pre-established funds; and
outputting on the mobile electronic device as a part of the at least subset a visual representation that corresponds with the additional source of pre-established funds.

17. The mobile electronic device of claim 16 wherein the operations further comprise receiving from the computerized device as the set of identification information a series of inputs detected on the input apparatus of the mobile electronic device.

18. The mobile electronic device of claim 11 wherein the operations further comprise:
determining that the mobile electronic device is situated at or within a predetermined proximity of a predetermined location;
responsive to the determining, receiving on the mobile electronic device at least one of:
a notification that at least one source of pre-established funds of the number of sources of pre-established funds is available for use at the predetermined location, and
a suggestion to purchase an additional source of pre-established funds that is usable at the predetermined location.

19. The mobile electronic device of claim 11 wherein the virtual wallet is stored in a storage remote from the mobile electronic device, and wherein the operations further comprising placing the mobile electronic device in wireless communication with the virtual wallet.

20. A method of providing on a mobile electronic device access to a reward that is based at least in part upon a purchase of a source of pre-established funds, the mobile electronic device having a processor apparatus that includes a processor and a storage, an input apparatus that is structured to provide input signals to the processor apparatus, and an output apparatus that is structured to receive output signals from the processor apparatus, the method comprising:
receiving from a computerized device a number of inputs that result in a purchase of a source of pre-established funds, the computerized device being one of the mobile electronic device and another electronic device;
responsive to the receiving, storing in a virtual wallet a set of identification information for the source of pre-established funds;
outputting on the mobile electronic device a visual representation that corresponds with the source of pre-established funds; and
adding to a set of rewards a reward that is based at least in part upon the purchase of the source of pre-established funds, the set of awards being associated with at least one of the virtual wallet and an owner of the virtual wallet.
